(19) United States
(12) Patent Application Publication
(10) Pub. No.: US 2008/0000942 A1
(43) Pub. Date: Jan. 3, 2008

(54) Magazine for Screws, and a Method and Material for Producing the Magazine

(76) Inventor: Fred Sundstrom, Ostersund (SE)

Correspondence Address: YOUNG & THOMPSON, 745 SOUTH 23RD STREET, 2ND FLOOR, ARLINGTON, VA, 22202, US

(21) Appl. No.: 11/596,413

(22) PCT Filed: May 10, 2005
(86) PCT No.: PCT/SE05/00669

§ 371 Date: Jan. 10, 2007

(30) Foreign Application Priority Data
May 14, 2004 (SE) 0401246-4

(51) Int. Cl. F16B 27/00

(52) U.S. Cl. 227/120; 206/338; 229/103.2; 411/85

(57) ABSTRACT

A magazine for screws, includes a body (1), which is delimited by a pair of opposite long sides, a pair of opposite short sides, and opposite top and bottom sides, and a plurality of through bores, which mouth in the top side as well as the bottom side and are delimited by flexible and demolishable limiting walls, a plurality of head-provided screws (8) being applied in some of the bores with the heads located in the area of the top side of the body and having the tips pointing toward the bottom side. The top side is covered by a covering film (2), which guarantees that the screws are reliably retained in the bores thereof. A material and a method for producing such magazines are also disclosed.

### TECHNICAL FIELD OF THE INVENTION

In a first aspect, this invention relates to a magazine intended for the storage of screws, of the type that comprises a body, which is delimited by a pair of opposite long sides, a pair of opposite short sides, as well as opposite top and bottom sides, and which includes a plurality of bores, which mouth in the top side as well as the bottom side and are delimited by flexible and demolishable limiting walls, a plurality of head-provided screws being applied in some of the bores with the heads located in the area of the top side of the body and with the tips pointing toward the bottom side.

### DESCRIPTION OF THE PRIOR ART

A magazine of the above-mentioned type is previously known by WO 0109526. A substantial advantage of this magazine is that the same to a large extent facilitates tightening of screws by means of power drilling screwdrivers. Instead of picking up screws one after the other from, for instance, a carton or a clothing pocket, the user may quickly and simply apply the proper magazine against the object in which a screw should be tightened, and then the so-called bit of the drilling screwdriver is applied in a most often cruciform seat in the head of the screw, in order to concludingly, in an operation carried out quickly, bring the screw to rotate so that the same is tightened in the object. The magazine offers a particular advantage so far that the screw in a reliable way is guided perpendicularly to the planar bottom side of the magazine and thereby in the desired driving-in direction.

A shortcoming of the known magazine has, however, turned out to be that the holding of the screws in the appurtenant bore in the body at times may be lost. Initially, all screws in the magazine are located with the heads thereof on a level with the top side of the magazine. In connection with handling and transportations a shorter or longer time after the moment of production, it may, however, occur that individual screws either entirely come loose out of the appurtenant bore or are displaced upward in the bore so that the head protrudes a distance from the top side of the magazine. For many different reasons, this is not desirable. Thus, the loss of a screw means an economic disadvantage, while a projecting screw may aggravate the tightening as well as give rise to damage in the surroundings, e.g., in articles of clothing.

In this connection, it should be particularly pointed out that magazines of the kind in question have to be possible to be manufactured at extremely low costs by mass production, because otherwise the competition from plain packages in the form of cardboard boxes or plastic bags may become superior.

### OBJECTS AND FEATURES OF THE INVENTION

In a first aspect, the present invention aims at obviating the above-mentioned shortcoming of the previously known magazine and at providing an improved magazine for screws. Therefore, a primary object of the invention is to provide a magazine, which by means of utmost simple and inexpensive means guarantees that the screws are kept long-term secured in the different bores of the magazine body. An additional object is to provide a magazine, the body of which is built up in such a way that the magazine in its entirety can be mass-produced at a low cost. It is also an object to provide a magazine the shape of which facilitates the work of the user in connection with the tightening of the screws.

According to the invention, at least the primary object is attained by the features defined in the characterizing clause of claim 1. Preferred embodiments of the magazine according to the invention are further defined in the dependent claims 2-6.

In a second aspect the invention also relates to a method for producing the magazine according to the invention. The features of this method are seen in claims 7 and 8.

In a third aspect, the invention also relates to a material for producing magazines according to the invention. The features of this material are seen in claim 9.

### BRIEF DESCRIPTION OF THE APPENDED DRAWINGS

In the drawings:

FIG. 1 is a perspective view of a completed magazine according to the invention, a covering film being shown applied to the outside of the body of the magazine,

FIG. 2 is a perspective exploded view showing the covering film separated from the body,

FIG. 3 is a perspective view of solely the proper body having screws applied therein, one of which, however, is shown separated from the body,

FIG. 4 is a perspective view of the magazine according to FIG. 1, although regarded from the bottom side (which is not visible in FIG. 1) of the magazine,

FIG. 5 is a schematic end view showing two screws placed side by side in the body of the magazine,

FIG. 6 is a partial perspective view illustrating how holes being formed in the covering film,

FIG. 7 is a planar view of a material according to the invention,

FIG. 8 is a perspective view of the material according to FIG. 7 in a partly folded state,

FIG. 9 is a perspective view of a body completed by means of said material,

FIG. 10 is a planar view of a girdle-like cover of the body according to FIG. 9, and

FIG. 11 is a perspective view illustrating how the cover being applied to the outside of the body.

### DETAILED DESCRIPTION OF A PREFERRED EMBODIMENT OF THE INVENTION

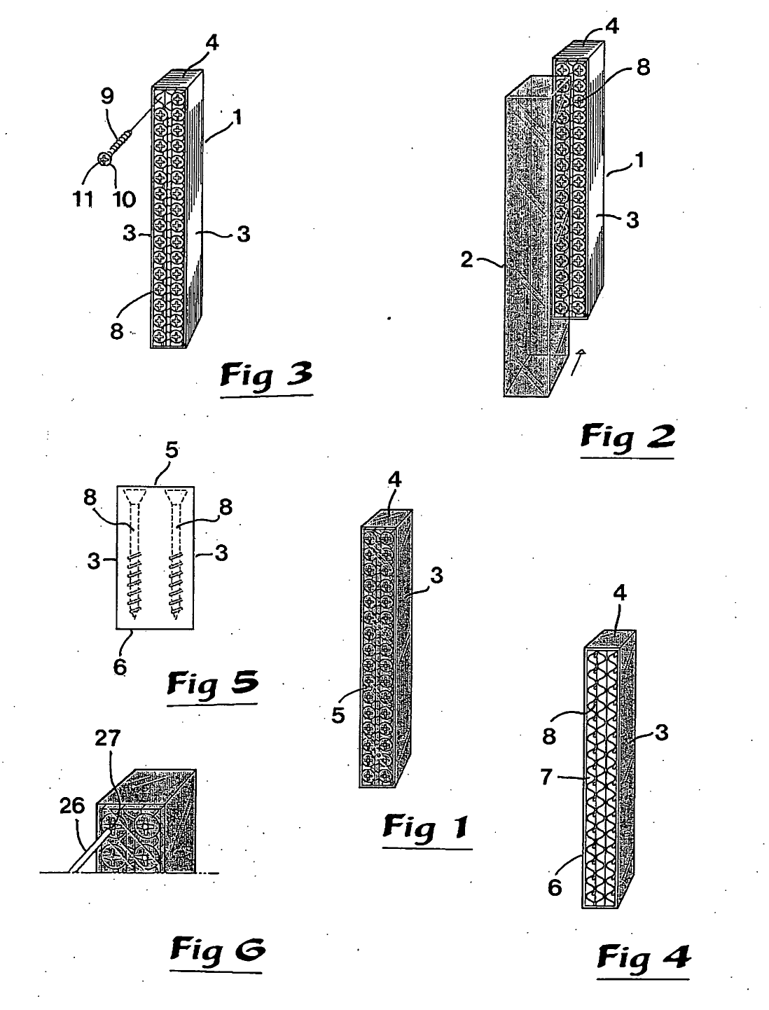

The magazine shown in FIGS. 1-5 includes, on one hand, a body in its entirety designated 1, and on the other hand a covering film designated 2. In the shown, preferred example, the body 1 is manufactured from corrugated cardboard, and has a long narrow, parallelepipedic basic shape. More precisely, the body is delimited by a pair of opposite long sides 3, a pair of opposite short sides 4, as well as opposite top and bottom sides 5 and 6, respectively. In the body, a plurality of bores or hollow spaces 7 are included, which are delimited by the various paper layers in the corrugated cardboard. In some of these bores, screws 8 are applied, of the type that is suitable for tightening by means of power drilling screwdrivers. As is seen in FIG. 3, each screw includes, in the usual way, a threaded shank 9 having a tip, i.e., a head 10 including a cruciform seat 11 for the bit of the drilling screwdriver.

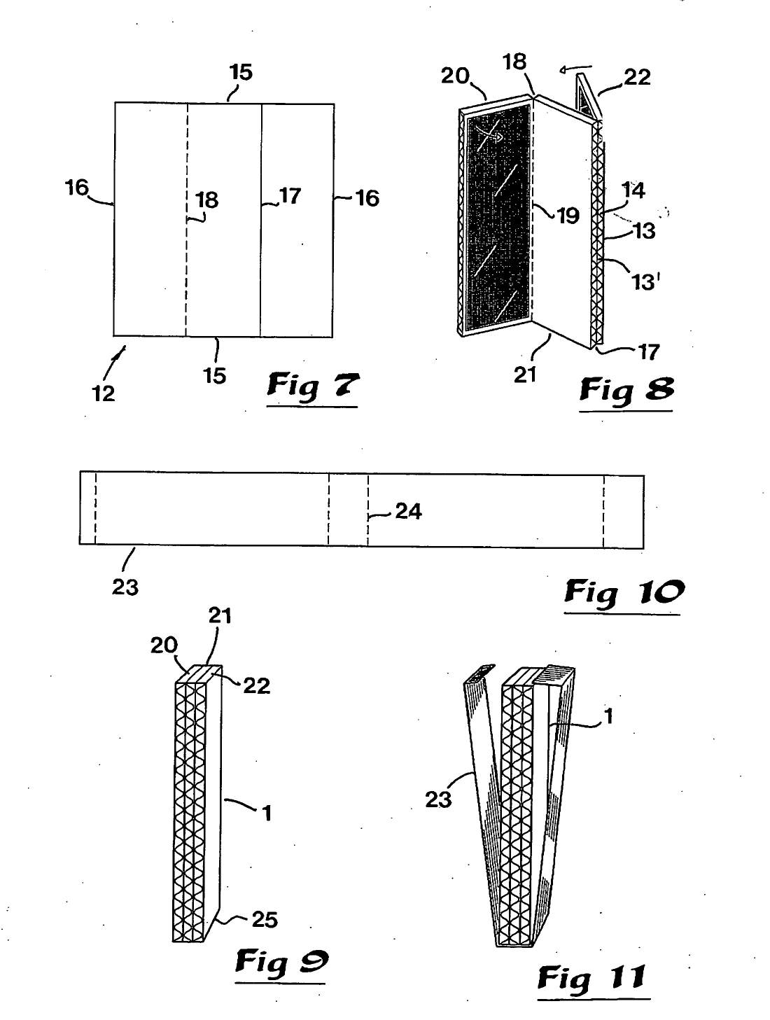

Now reference is made also to FIGS. 7-11, which illustrate a preferred way of manufacturing the magazine according to the invention. In FIGS. 7 and 8, a material 12 is shown for the formation of the body 1. This material consists of corrugated cardboard, more precisely corrugated cardboard of the single-layer type. Such corrugated cardboard is characterized in that it is composed of two outer, planar layers or walls 13, 13′ of paper, and an intermediate paper layer 14, which is waved. The crests of these wave formations are glued on to the inside of the outer layers 13, 13′. The bores 7 for the screws are formed by the valleys between nearby crests in the intermediate core 14.

The material 12 according to FIG. 7 has a quadrangular basic shape, which is determined by two pairs of opposite edges 15, 16. In a first step during the manufacture of the body, two 17, 18 are cut out in the material 12, which cuts are mutually parallel as well as parallel to the edges 16. These cuts are cut out in opposite sides of the material. Thus, as is seen in FIG. 8, the cut 17 intersects. one of the two planar paper layers, namely the layer 13, but not the other layer 13′ (in addition, the main part of the waved core layer 14 is cut). The cut 18, in turn, intersects the layer 13′, but not the layer 13. Thus, in the bottom of each cut, a paper fillet serving as a folding notch 19 remains, around which the different corrugated cardboard sections can be folded. The cuts 17, 18 delimit three different corrugated cardboard sections 20, 21, 22, each one of which can be folded against a nearby section. In FIG. 9, the corrugated cardboard sections 20, 21, 22 are shown in a completely folded state. In this state, the sections may be held together by means of a glue joint (not shown) between the respective sections. In other words, the corrugated cardboard sections are kept together in an integrated body of a long narrow, parallelepipedic shape.

In FIG. 10, a girdle-like cover 23 is shown, the width of which is equally large as the height of the long and short sides, and the length of which is somewhat larger than the circumference of the body shown in FIG. 9. In this cover, four folding notches 24 are applied, the location of which along the cover corresponds with the distances between the four corners 25 of the body 1. In one step, which is visualised in FIG. 11, the body is completed by the fact that the cover 23 is applied to the outside of the short and long sides of the body and is fixed, e.g., by agglutination.

In the next manufacturing step, the screws 8 are applied in a bore 7 each. More precisely, the screws are applied in two separated, mutually parallel rows by being inserted into at least some bores, e.g., every second bore, in the two outer corrugated cardboard sections 20, 22, as is shown in FIG. 3. However, no screws are applied in the intermediate, core-like corrugated cardboard section 21. This means that each individual screw will be surrounded by three empty bores. In such a way, it is guaranteed that the screws in connection with tightening can be detached from the magazine without being blocked by nearby screws. More Precisely, the individual screw can be driven out through the bottom side of the magazine while the flexible paper walls becoming demolished.

In accordance with the invention, in a final step, the covering film 2, which is shown in FIG. 2, is applied to the body. This covering film is imparted an area that is larger than the top side 5, so that the same covers not only the top side, but also parts of the long and short sides 3, 4. Advantageously, the film is given a size that makes the same covering the long and short sides in their entirety, but not the bottom side. By means of a punching tool comprising equally many needles as the number of screws in the magazine, holes for the screws are recessed in the film. This is schematically illustrated in FIG. 6, which shows how a needle 26 recesses a diminutive hole 27 in the area of the centre of the screw head. By means of this hole, the insertion of a screwdriver bit in the cruciform seat of the head is facilitated.

Although the dimensions of the magazine and the number of screws may be varied within fairly wide limits, the embodiment shown in the drawings is preferred. In the example, the body of the magazine has been made from 5 mm corrugated cardboard, involving that the width of the completed magazine amounts to approx. 15 mm (in this connection, it should be pointed out that an additional corrugated cardboard layer may be inserted between the body shown in the drawings and the outer cover 23, the width of the body increasing to 20 to 25 mm). The height of the body, such as this is determined by the distances between the cuts 17, 18 and the edges 16, should be somewhat larger than the length of the screws 8. For instance, for 35 mm screws, the magazine should have a height of 37 mm. In such a way, it is guaranteed that the tips of the screws are located inside the bottom side 6 of the body, as is shown in FIG. 5. The length of the magazine may advantageously be within the range of 150-250 mm, depending on the number of screws that should be included. If 50 screws in total should be included and are arranged in two rows having 25 screws each, the length of the magazine will amount to approx. 225 mm. With these dimensions, a magazine is obtained that has moderate weight and is simple and convenient to handle by the user.

An essential advantage of the magazine according to the invention is that the screws are secured in an absolutely reliable way in the appurtenant bore, even if the magazine is subjected to miscellaneous phenomena aiming to release the screws, e.g., vibrations.

1. Magazine for screws, comprising a body (1), which is delimited by a pair of opposite long sides (3), a pair of opposite short sides (4), and opposite top and bottom sides (5, 6), and which includes a plurality of bores (7), which mouth in the top side (5) as well as the bottom side (6) and is delimited by flexible and demolishable walls, a plurality of screws (8) being applied in some bores (7) with the heads (10) located in the area of top side (5) of the body and with the tips pointing toward the bottom side (6), characterized in that a penetratable film (2) is attached to the body (1), which film covers the top side (5).

2. Magazine according to claim 1, characterized in that the covering film (2) consists of a piece of shrinkable plastic, which has a larger area than the top side (5) of the body (1), and is attached to the body by being shrink-fitted against the long and short sides (3, 4), respectively, thereof.

3. Magazine according to claim 2, characterized in that the covering film (2) ends on a level with the bottom side (6) of the body without covering the same.

4. Magazine according to claim 1, the body comprising at least three sections (20, 21, 22) of corrugated cardboard located side by side, of the type that is composed of two outer, planar paper layers (13, 13′) and an intermediate core (14) of a waved paper web, characterized in that the body is manufactured from a corrugated cardboard material (12) made with quadrangular basic shape, in which material two parallel cuts (17, 18) are cut out from opposite sides, which cuts delimit three conformal, rectangular and integrally continuous corrugated cardboard sections (20, 21, 22), and which provide two folding notches (19), around which the three sections are folded next to each other while forming a continuous body of a long narrow, parallelepipedic basic shape, a plurality of screws (8) being applied in the bores in the two outer corrugated cardboard sections (20, 22), while the bores in the intermediate corrugated cardboard section (21) are empty.

5. Magazine according to claim 1, characterized in that the same comprises a cover (23) made of cardboard, which cover endlessly surrounds said long and short sides (3, 4).

6. Magazine according to claim 1, characterized in that a hole (26) is recessed in the covering film (2) for each screw (8) in order to facilitate the insertion of a tool in a seat (11) in the head (10) of the screw.

7. Method for producing a magazine for screws according to claim 4, characterized by the steps of:
a) providing a corrugated cardboard material (12) of a quadrangular basic shape,
b) applying, from opposite sides of the material, two parallel cuts (17, 18) which intersect one of the planar paper layers of the material, but not the other, while delimiting three rectangular corrugated cardboard sections (20, 21, 22),
c) folding and securing the three corrugated cardboard sections (20, 21, 22) to each other while forming a form-stiff, long narrow and parallelepipedic body,
d) applying screws in the bores in the two outer corrugated cardboard sections (20, 22) of the body, but not in the intermediate (21) one, and
e) applying, on the outside of the body, a shrinkable plastic film (2) which covers the top side (5) of the body and thereby the screw heads (10), but not the bottom side (6) of the body.

8. Method according to claim 7, characterized in that the shrinkable plastic film is given such a size that the same ends on a level with the bottom side of the body without covering the same.

9. Material for the manufacture of a packing magazine according to claim 4, characterized in that the same consists of a quadrangular piece of corrugated cardboard having two outer, planar paper layers (13, 13′) and an intermediate, waved paper layer (14), in opposite outer paper layers two mutually parallel cuts (17, 18) being cut out, which delimit three conformal corrugated cardboard sections (20, 21, 22).

10. Method for producing a magazine for screws according to claim 5 characterized by the steps of:
a) providing a corrugated cardboard material (12) of a quadrangular basic shape,
b) applying, from opposite sides of the material, two parallel cuts (17, 18) which intersect one of the planar paper layers of the material, but not the other, while delimiting three rectangular corrugated cardboard sections (20, 21, 22),
c) folding and securing the three corrugated cardboard sections (20, 21, 22) to each other while forming a form-stiff, long narrow and parallelepipedic body,
d) applying screws in the bores in the two outer corrugated cardboard sections (20, 22) of the body, but not in the intermediate (21) one, and
e) applying, on the outside of the body, a shrinkable plastic film (2) which covers the top side (5) of the body and thereby the screw heads (10), but not the bottom side (6) of the body.

11. Method for producing a magazine for screws according to claim 6 characterized by the steps of:
a) providing a corrugated cardboard material (12) of a quadrangular basic shape,
b) applying, from opposite sides of the material, two parallel cuts (17, 18) which intersect one of the planar paper layers of the material, but not the other, while delimiting three rectangular corrugated cardboard sections (20, 21, 22),
c) folding and securing the three corrugated cardboard sections (20, 21, 22) to each other while forming a form-stiff, long narrow and parallelepipedic body,
d) applying screws in the bores in the two outer corrugated cardboard sections (20, 22) of the body, but not in the intermediate (21) one, and
e) applying, on the outside of the body, a shrinkable plastic film (2) which covers the top side (5) of the body and thereby the screw heads (10), but not the bottom side (6) of the body.

12. Material for the manufacture of a packing magazine according to claim 5, characterized in that the same consists of a quadrangular piece of corrugated cardboard having two outer, planar paper layers (13, 13′) and an intermediate, waved paper layer (14), in opposite outer paper layers two mutually parallel cuts (17, 18) being cut out, which delimit three conformal corrugated cardboard sections (20, 21, 22).

13. Material for the manufacture of a packing magazine according to claim 6, characterized in that the same consists of a quadrangular piece of corrugated cardboard having two outer, planar paper layers (13, 13′) and an intermediate, waved paper layer (14), in opposite outer paper layers two mutually parallel cuts (17, 18) being cut out, which delimit three conformal corrugated cardboard sections (20, 21, 22).
